(19) United States
(12) Patent Application Publication
(10) Pub. No.: US 2020/0291696 A1
(43) Pub. Date: Sep. 17, 2020

(54) OPENING AND CLOSING BODY APPARATUS AND STORAGE APPARATUS

(71) Applicant: NIHON PLAST CO., LTD., Shizuoka (JP)

(72) Inventor: Takaaki SEKI, Shizuoka (JP)

(21) Appl. No.: 16/819,224

(22) Filed: Mar. 16, 2020

(30) Foreign Application Priority Data
Mar. 15, 2019 (JP) 2019-049032
Jan. 22, 2020 (JP) 2020-008575

(51) Int. Cl. E05C 3/00; B60R 7/04; E05C 3/14

(52) U.S. Cl. CPC E05C 3/004; E05Y 2900/538; E05C 3/14; B60R 7/04

(57) ABSTRACT

Provided is a console box capable of reducing a sound generated in the event of abutment between abutting sections with a simple configuration.

Console box 10 includes box 12 and lid 13 opening and closing at least a part of box 12. Lid 13 includes lid body main body 21 movable with respect to box 12 and locking section 22 movable with respect to lid body main body 21 and locking lid 13 to box 12. At least one of box 12 and lid body main body 21 has abutting section 28. Locking section 22 has abutting section 43 abutting against abutting section 28 when lid 13 is locked to box 12. At least one of abutting section 28 and abutting section 43 is a deformation section absorbing an impact by being deformed at least in part by abutting against the other.

### CROSS REFERENCE TO RELATED APPLICATIONS

This application is entitled to and claims the benefit of Japanese Patent Applications No. 2019-049032 filed on Mar. 15, 2019 and No. 2020-008575 filed on Jan. 22, 2020, the disclosures of which including the specification, drawings and abstract are incorporated herein by reference in its entirety.

### TECHNICAL FIELD

The present invention relates to an opening and closing body apparatus having a locking section locking an opening and closing body opening and closing at least a part of a main body to the main body and holding the opening and closing body in the main body and a storage apparatus including the opening and closing body apparatus.

### BACKGROUND ART

Known in the related art is a console box as a storage apparatus disposed between, for example, the driver's seat and the passenger seat of an automobile. The console box includes a box main body that is a storage body as a main body having an opening section in the upper surface of the main body or the like and a lid body as an opening and closing body opening and closing the opening section of the box main body. The lid body is locked to the box main body by a hook that is a locking section biased by a spring. When the hook climbs over a latch section provided on the box main body at this time, the hook abuts against a lid body main body by the biasing of the spring. An absorbing member for impact absorption is attached to the hook or the lid body main body such that an unpleasant sound (low-pitched sound) in a high frequency band is not generated during that abutment (see, for example, PTL 1).

### CITATION LIST

### Patent Literature

### PTL 1

### Japanese Translation of a PCT Application Laid-Open No. 2018-527239 (Pages 2-4, FIG. 2)

### SUMMARY OF INVENTION

### Technical Problem

However, the configuration described above requires the separate absorbing member formed of rubber or an elastomer. In addition, in a case where the absorbing member is incapable of sufficiently absorbing an impact, a further impact absorbing structure may be necessary such that an unpleasant sound attributable to contact between the synthetic resins of the hook and the absorbing member is not generated.

The present invention has been made in view of such a point, and an object of the present invention is to provide an opening and closing body apparatus capable of reducing a sound generated in the event of abutment between first and second abutting sections with a simple configuration and a storage apparatus including the opening and closing body apparatus.

### Solution to Problem

An opening and closing body apparatus according to claim 1 includes a main body and an opening and closing body opening and closing at least a part of the main body, in which the opening and closing body includes an opening and closing body main body movable with respect to the main body and a locking section movable with respect to the opening and closing body main body, locking the opening and closing body to the main body, and holding the opening and closing body in the main body, at least one of the main body and the opening and closing body main body has a first abutting section, the locking section has a second abutting section abutting against the first abutting section when the opening and closing body is locked to the main body by the locking section, and at least one of the first abutting section and the second abutting section is a deformation section absorbing an impact by being deformed at least in part by abutting against the other.

In the opening and closing body apparatus according to claim 2, which is the opening and closing body apparatus according to claim 1, at least one of the first abutting section and the second abutting section is a deformation section provided with an abutting main body section extending along a direction intersecting with a direction of abutment against the other and abutting against the other and a bent section formed to be continuous with the abutting main body section.

In the opening and closing body apparatus according to claim 3, which is the opening and closing body apparatus according to claim 2, the bent section is set to be smaller in thickness than a part around the bent section.

In the opening and closing body apparatus according to claim 4, which is the opening and closing body apparatus according to any one of claims 1 to 3, the deformation section is provided with a hole portion.

In a storage apparatus according to claim 5, which includes the opening and closing body apparatus according to any one of claims 1 to 4, a main body is a storage body having an opening section and an accommodating section communicating with the opening section and accommodating an object and an opening and closing body is a lid body opening and closing the opening section.

### Advantageous Effects of Invention

According to the opening and closing body apparatus described in claim 1, it is possible to reduce the sound that is generated in the event of abutment between the first abutting section and the second abutting section with a simple configuration and without using a separate member or the like by using at least one of the first abutting section and the second abutting section as a deformation section absorbing an impact by being deformed at least in part by abutting against the other.

According to the opening and closing body apparatus described in claim 2, the effect of the opening and closing body apparatus described in claim 1 can be obtained and, in addition, the abutting main body section can be easily deformed from the position of the bent section and the sound generated in the event of abutment between the first abutting section and the second abutting section can be easily reduced by at least one of the first abutting section and the second abutting section being provided with the abutting main body section extending along a direction intersecting with the direction of abutment against the other and the bent section being provided to be continuous with the abutting main body section.

According to the opening and closing body apparatus described in claim 3, the effect of the opening and closing body apparatus described in claim 2 can be obtained and, in addition, the abutting main body section can be more easily deformed at the position of the bent section and the sound generated in the event of abutment between the first abutting section and the second abutting section can be reduced by the bent section being set to be smaller in thickness than a part around the bent section.

According to the opening and closing body apparatus described in claim 4, the effect of the opening and closing body apparatus described in any one of claims 1 to 3 can be obtained and, in addition, the deformation section can be more easily deformed and the sound generated in the event of abutment between the first abutting section and the second abutting section can be reduced by a hole being provided in the deformation section and the sound generated in the event of abutment between the first abutting section and the second abutting section can be adjusted by setting shape and size of the hole.

According to the storage apparatus described in claim 5, it is possible to control the sound generated by abutment between the first abutting section and the second abutting section when the opening section is closed by the lid body with an inexpensive, lightweight, and simple configuration having a small number of components by providing the opening and closing body apparatus according to any one of claims 1 to 4.

### BRIEF DESCRIPTION OF DRAWINGS

FIG. 1 is a cross-sectional view illustrating a state of abutment between first and second abutting sections of a storage apparatus as an opening and closing body apparatus of Embodiment 1 of the present invention;

FIG. 2 is a perspective cross-sectional view illustrating a part of the storage apparatus;

FIG. 3 is a perspective view illustrating a locking section of the storage apparatus;

FIG. 4 is a perspective view illustrating the storage apparatus;

FIG. 5 is a graph illustrating an example and a comparative example of analysis data on a sound generated by abutment between the first and second abutting sections of the storage apparatus;

FIG. 6 is a perspective view illustrating a deformation section of a storage apparatus as an opening and closing body apparatus of Embodiment 2 of the present invention;

FIG. 7 is a perspective view illustrating a deformation section of a storage apparatus as an opening and closing body apparatus of Embodiment 3 of the present invention;

FIG. 8 is a perspective view illustrating a deformation section of a storage apparatus as an opening and closing body apparatus of Embodiment 4 of the present invention;

FIG. 9 is a perspective view illustrating a deformation section of a storage apparatus as an opening and closing body apparatus of Embodiment 5 of the present invention;

FIG. 10 is a perspective view illustrating a deformation section of a storage apparatus as an opening and closing body apparatus of Embodiment 6 of the present invention;

FIG. 11 is a perspective view illustrating a deformation section of a storage apparatus as an opening and closing body apparatus of Embodiment 7 of the present invention;

FIG. 12 is a perspective cross-sectional view illustrating a part of a storage apparatus as an opening and closing body apparatus of Embodiment 8 of the present invention;

FIG. 13 is a perspective view illustrating a cushioning material and a first abutting section of the storage apparatus;

FIG. 14 is a perspective view illustrating a locking section of the storage apparatus;

FIG. 15 is a graph illustrating a relationship between a change in compression amount of a cushioning material by adjustment of a contact area between the first abutting section and a second abutting section of the storage apparatus and a sound generated by abutment between the first and second abutting sections; and

FIG. 16 is a cross-sectional view illustrating a deformation section of a storage apparatus as an opening and closing body apparatus of Embodiment 9 of the present invention.

### DESCRIPTION OF EMBODIMENTS

Hereinafter, the configuration of Embodiment 1 of the present invention will be described with reference to the drawings.

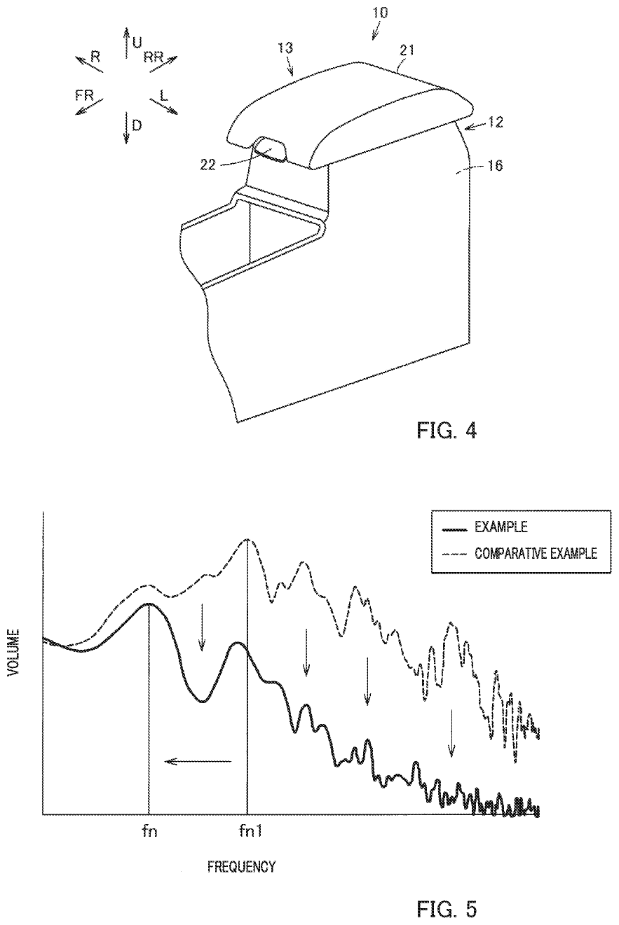

In FIG. 4, 10 denotes a console box that is a storage apparatus as an opening and closing body apparatus. This console box 10 constitutes a part of a center console positioned between the front seats of a vehicle such as an automobile, that is, a driver's seat and a passenger seat. This console box 10 includes box main body 12 that is a storage body as a main body attached to the vehicle body side of the automobile and lid body 13 as an opening and closing body movably attached to box main body 12. Hereinafter, directions such as front-rear, both lateral, and up-down directions will be described with reference to a state where console box 10 is attached to the vehicle body and arrow FR direction is the frontward direction, arrow RR direction is the rearward direction, arrow L direction is the leftward direction, arrow R indicates the rightward direction, arrow U indicates the upward direction, and arrow D indicates the downward direction in the drawings.

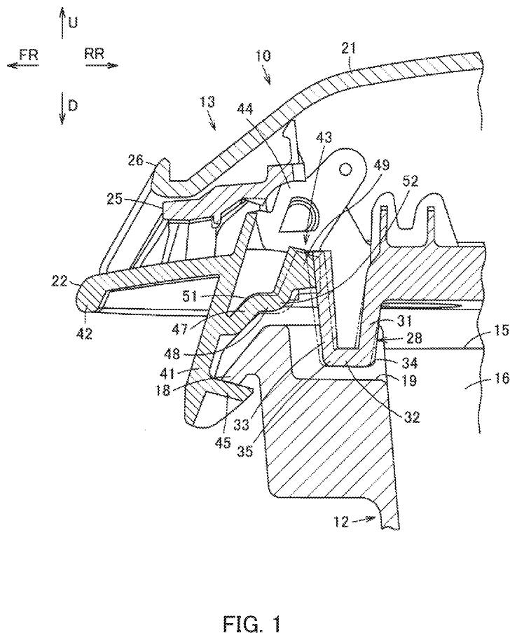

Box main body 12 is formed of a synthetic resin and in a box shape. As illustrated in FIG. 1, box main body 12 includes opening section 15, which is a section to be opened and closed, in the upper end section of box main body 12. Opening section 15 of the present embodiment is formed in a quadrangular shape that is long in the front-rear direction and short in the left-right direction. Opening section 15 is partitioned in box main body 12 and communicates with accommodating section 16 accommodating an object. In addition, box main body 12 includes a support section supporting lid body 13. The support section pivotably supports lid body 13. The support section is disposed on both sides of the rear section of box main body 12. In addition, the support section is formed behind opening section 15. In addition, box main body 12 includes latch section 18 locking lid body 13. Latch section 18 is disposed in an end section that is on the side which is opposite to the support section, which is the front section of box main body 12 in the present embodiment. Latch section 18 is positioned in an edge section of opening section 15. Latch section 18 protrudes to be inclined downward toward the front that is the outside of opening section 15. Further, box main body 12 includes recessed section 19 behind latch section 18 and a part of lid body 13 is inserted into recessed section 19. Recessed section 19 is formed to be continuous with opening section 15 and the upper and rear parts of recessed section 19 are open.

Lid body 13, which is also called a lid or the like, opens and closes opening section 15 of box main body 12 by pivoting. In addition, lid body 13 may function as an armrest on which an occupant places his or her elbow or the like in a state where opening section 15 is closed. Lid body 13 includes lid body main body 21 as an opening and closing body main body movable with respect to box main body 12 and locking section 22 provided on lid body main body 21 and locking lid body 13 to box main body 12.

Lid body main body 21 is positioned in the upper section of console box 10. Lid body main body 21 is formed of a synthetic resin. Although lid body main body 21 is capable of having any shape insofar as lid body main body 21 is capable of covering opening section 15, lid body main body 21 is formed in a quadrangular shape that is long in the front-rear direction in the present embodiment. In addition, lid body main body 21 includes a supported section that is pivotably supported by the support section of box main body 12. In other words, in the present embodiment, lid body main body 21 has the supported section in a rear section of lid body main body 21 and is capable of opening and closing opening section 15 by a front section of lid body main body 21 pivoting in the up-down direction with respect to box main body 12. In addition, lid body main body 21 may be biased in the direction to open opening section 15 by biasing means such as a spring and a damper. Further, although lid body main body 21 may be divided into any parts, lid body main body 21 is formed by lower member 25 as a first member and upper member 26 as a second member being combined in the up-down direction in the present embodiment. In addition, at least an outer surface of lid body main body 21 may be covered with a skin body such as leather or cloth.

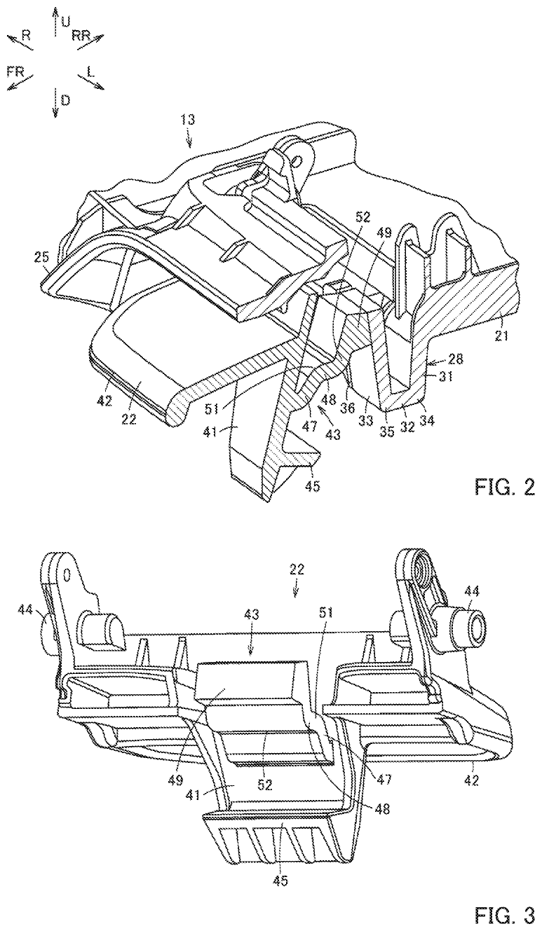

Further, first abutting section 28 is formed on lid body main body 21. First abutting section 28 is a part that abuts against a locking section 22 side in a state where lid body 13 is closed and lid body 13 is locked to box main body 12 by locking section 22. In the present embodiment, first abutting section 28 abuts against the locking section 22 side along the front-rear direction. First abutting section 28 is disposed in the lower section of lid body main body 21. In the present embodiment, first abutting section 28 is formed integrally with lower member 25. In addition, first abutting section 28 is positioned to face locking section 22. In other words, in the present embodiment, first abutting section 28 is positioned in the front section of lid body main body 21. First abutting section 28 integrally includes first connection section 31 extending along the up-down direction, first extending section 32 as an extending section extending along the front-rear direction, and first abutting main body section 33 as an abutting main body section extending along the up-down direction, and a part where first connection section 31 and first extending section 32 are continuous and a part where first extending section 32 and first abutting main body section 33 are continuous are respectively formed as first bent sections 34 and 35, which are bent sections that are bent and deformed. In addition, the left and right sides (only one illustrated in the drawings) of first abutting section 28 are isolated from lid body main body 21 via slit 36 illustrated in FIG. 2. Accordingly, first abutting section 28 is a leaf spring-shaped deformation section (seismic isolation structure) that is elastically deformable in the front-rear direction.

As illustrated in FIGS. 1 and 2, first connection section 31 has a proximal end section continuous with lid body main body 21. In the present embodiment, first connection section 31 extends downward from a proximal end section toward a distal end section of first connection section 31.

A rear end section (one end section) of first extending section 32 is continuous with a distal end section of first connection section 31 via first bent section 34, and a front end section (the other end section) of first extending section 32 is continuous with a proximal end section of first abutting main body section 33 via first bent section 35. Accordingly, first connection section 31 and first extending section 32 are continuous in a crank shape.

In the present embodiment, first abutting main body section 33 extends upward from the proximal end section of first abutting main body section 33 toward the distal end section of first abutting main body section 33. In other words, first abutting main body section 33 is separated from the front of first connection section 31 and is at a position facing first connection section 31. In addition, the distal end section of first abutting main body section 33 is formed in a free end shape. Accordingly, in the present embodiment, first abutting section 28 is formed in a U shape when viewed from the side. Although a front surface of first abutting main body section 33, which is a surface on the side that is opposite to first connection section 31, is a part abutting directly against the locking section 22 side in the present embodiment, a cushioning member may be attached to the front surface.

Locking section 22 illustrated in FIGS. 1 to 3 is also called a lever and is engaged with latch section 18 of box main body 12. Locking section 22 is disposed on the side that is opposite to the supported section of lid body main body 21, which is the front section in the present embodiment. Locking section 22 is biased by locking biasing means such as a spring and configured such that the locking state of lid body 13 is maintained by the biasing of this locking biasing means and the locking can be released by an external operation performed by an occupant or the like.

Locking section 22 is formed of a synthetic resin. Locking section 22 integrally includes locking section main body 41, operated section 42 extending from locking section main body 41, and second abutting section 43 abutting against first abutting section 28.

Locking section main body 41 is positioned to extend along the up-down direction. Locking section main body 41 includes support section 44, which is pivotably supported with respect to lid body main body 21, in both side sections an the upper end section side that is one end section. In the present embodiment, locking section main body 41 is pivotably supported by lower member 25. Locking section 22 is pivotable from an upper front side to a lower rear side with respect to lid body main body 21. In addition, hook section 45 is formed in a lower end section of locking section main body 41, which is the other end section. Hook section 45 is provided to project toward a box main body 12 side. In other words, in the present embodiment, hook section 45 is provided to project in a claw shape rearward from locking section main body 41. Hook section 45 can be engaged with latch section 18 from below.

Operated section 42 is a finger hook section on which an occupant puts a finger in operating locking section 22. Operated section 42 extends to a side that is opposite to a direction of protrusion of hook section 45, that is, a front side in the present embodiment with respect to locking section main body 41. In addition, operated section 42 is formed in a plate shape extending along the left-right direction. Operated section 42 extends frontward from the front end section of lid body main body 21, and pivots locking section 22 against the biasing of the locking biasing means by being operated to be lifted from below.

Second abutting section 43 extends toward the box main body 12 side at a position separated from hook section 45 in locking section main body 41. In other words, in the present embodiment, second abutting section 43 extends rearward from a position above hook section 45 in a rear section of locking section main body 41. Second abutting section 43 integrally includes second connection section 47 extending along the up-down direction, second extending section 48 as an extending section extending along the front-rear direction, and second abutting main body section 49 as an abutting main body section extending along the up-down direction, and a part where second connection section 47 and second extending section 48 are continuous and a part where second extending section 48 and second abutting main body section 49 are continuous are respectively formed as second bent sections 51 and 52, which are bent sections. In addition, second abutting section 43 is formed in a plate shape and is a leaf spring-shaped deformation section (seismic isolation structure) that is elastically deformable in the front-rear direction.

Second connection section 47 has a proximal end section continuous with locking section main body 41. In the present embodiment, second connection section 47 extends upward from the proximal end section toward a distal end section of second connection section 47.

A front end section (one end section) of second extending section 48 is continuous with the distal end section of second connection section 47 via second bent section 51, and a rear end section (the other end section) of second extending section 48 is continuous with a proximal end section of second abutting main body section 49 via second bent section 52. Accordingly, second connection section 47 and second extending section 48 are continuous in a crank shape.

In the present embodiment, second abutting main body section 49 extends upward from the proximal end section of second abutting main body section 49 toward a distal end section of second abutting main body section 49. In other words, second abutting main body section 49 is separated from the front of second connection section 47 and is positioned above second connection section 47 and at a position not facing second connection section 47. The distal end section of second abutting main body section 49 is formed in a free end shape. Accordingly, in the present embodiment, second abutting section 43 is formed to be inclined upward and in a step shape when viewed from the side. Although the rear surface of second abutting main body section 49, which is a surface on the side that is opposite to second connection section 47, is a part abutting directly against the front surface of first abutting main body section 33 of first abutting section 28 in the present embodiment, a cushioning member may be attached to the rear surface.

Console box 10 is assembled by lid body 13 being formed by assembly of upper member 26 with respect to lower member 25 that pivotably supports locking section 22 and incorporates the locking biasing means, the supported section of this lid body 13 being pivotably supported by the support section of box main body 12, and the biasing means being attached between box main body 12 and lid body 13.

Console box 10 completed in this manner is assembled between, for example, the front seats in a passenger compartment of the vehicle. When operated section 42 of locking section 22 is lifted as necessary, locking section 22 pivots, the engagement of hook section 45 with latch section 18, that is, the locking of lid body 13 to box main body 12 is released, the force of the biasing by the biasing means is released, and lid body 13 pivots and is held at a maximum open position, where opening section 15 is open to the maximum, as a result.

When lid body main body 21 is pushed downward against the biasing of the biasing means in the case of closing of opening section 15 by lid body 13, hook section 45 of locking section 22 abuts against latch section 18, locking section 22 gradually pivots against the biasing of the locking biasing means while hook section 45 maintains contact with latch section 18 as lid body main body 21 is further pushed, locking section 22 is subjected to return pivoting (return movement) by the biasing of the locking biasing means at the position where hook section 45 has climbed over latch section 18, and hook section 45 is locked to latch section 18. At this time, second abutting section 43 abuts against first abutting section 28 from the front by the return pivoting (return movement) of locking section 22. More specifically, second abutting main body section 49 of second abutting section 43 abuts against first abutting main body section 33 of first abutting section 28 from the front surface. Then, in first abutting section 28, mainly first abutting main body section 33 is elastically bent and deformed from a position of first bent section 35 to a rear side, which is opposite to the direction of the abutment, as indicated by the two-dot chain line in FIG. 1. In addition, in second abutting section 43, mainly second abutting main body section 49 is elastically bent and deformed from the position of second bent section 52 to a front side in the direction opposite to the direction of the abutment. As a result, the impact at a time of abutment between first abutting section 28 and second abutting section 43 is absorbed and lock sound suppression is achieved.

By using at least one of first abutting section 28 and second abutting section 43 (both first abutting section 28 and second abutting section 43 in the present embodiment) as a deformation section absorbing an impact by being deformed at least in part by abutting against the other as described above, it is possible to reduce the lock sound that is generated in the event of abutment between first abutting section 28 and second abutting section 43 with a simple configuration and without using a separate member or the like.

Specifically, for example, the graph in FIG. 5 illustrates fast Fourier transform (FFT) analysis data on the lock sound generated in the event of abutment between first abutting section 28 and second abutting section 43 in relation to an example corresponding to the present embodiment and a comparative example corresponding to the related art. As illustrated in FIG. 5, in the example as compared with the comparative example, the volume (sound pressure level) in an unpleasant high frequency band can be reduced, the natural frequency fn1 of the comparative example can be shifted to the natural frequency fn on the low frequency band side, and the lock sound generated in the event of abutment between first abutting section 28 and second abutting section 43 can be turned into a pleasant sound.

Accordingly, it is possible to reduce the lock sound by means of the structure of at least one of first abutting section 28 and second abutting section 43 without a change in cost, weight, or the number of components.

In addition, first abutting main body section 33 and second abutting main body section 49 can be easily deformed from the positions of first bent section 35 and second bent section 52 and the lock sound generated in the event of abutment between first abutting section 28 and second abutting section 43 can be easily reduced by at least one of first abutting section 28 and second abutting section 43 (both first abutting section 28 and second abutting section 43 in the present embodiment) being provided with first abutting main body section 33 and second abutting main body section 49 extending along a direction intersecting with the direction of abutment against the other and first bent section 35 and second bent section 52 being provided to be continuous with first abutting main body section 33 and second abutting main body section 49.

Further, it is possible to easily change the frequency of the lock sound, the amount of reduction in the volume of the high frequency band, or the like as desired by changing the section modulus or bending moment of at least one of first abutting section 28 and second abutting section 43.

Since the discomfort of the lock sound can be reduced and the lock sound can be turned into a pleasant sound, it is possible to obtain a solid feeling or a sense of elegance as compared with the related art.

Moreover, even in the case of deterioration of or damage to the seismic isolation structure suppressing the lock sound by using at least one of first abutting section 28 and second abutting section 43 as a deformation section, the deterioration or damage acts in the direction in which locking section 22 approaches box main body 12, that is, in the direction in which the width of hooking of hook section 45 of locking section 22 onto latch section 18 increases, and thus the lock function is not affected.

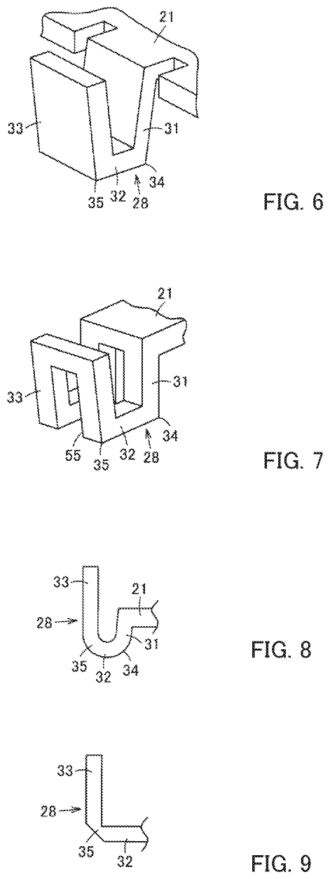

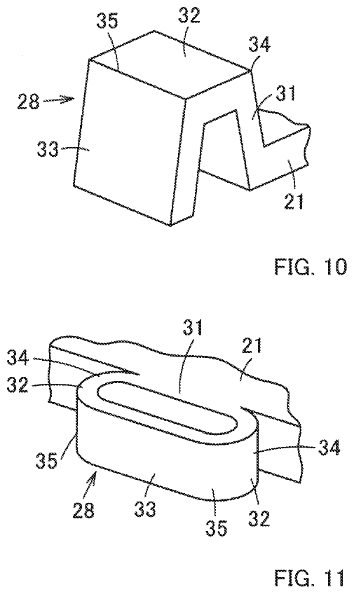

It should be noted that first abutting section 28 in Embodiment 1 described above may be formed to protrude in a tongue shape from lid body main body 21 as in Embodiment 2 illustrated in FIG. 6. In addition, hole 55 may be formed in first abutting section 28 as in Embodiment 3 illustrated in FIG. 7. Although hole 55 may have any shape, hole 55 in the present embodiment is, for example, a lightening hole formed over first connection section 31, first extending section 32, and first abutting main body section 33 of first abutting section 28. In this case, first abutting section 28 as a deformation section can be more easily deformed, the lock sound generated in the event of abutment between first abutting section 28 and second abutting section 43 can be reduced, first abutting section 28 can be reduced in weight, and the lock sound generated in the event of abutment between first abutting section 28 and second abutting section 43 can be adjusted by setting the shape and size of hole 55. Further, the shape in which first bent sections 34 and 35 of first abutting section 28 are bent may be an angled and pointed shape or may be a circular arc shape as in Embodiment 4 illustrated in FIG. 8. In addition, first bent section 35 of first abutting section 28 may be formed to be smaller in thickness, that is, thinner than the part around first bent section 35 as in Embodiment 5 illustrated in FIG. 9. In this case, first abutting main body section 33 can be more easily deformed at the position of first bent section 35, the lock sound generated in the event of abutment between first abutting section 28 and second abutting section 43 can be reduced, and it is possible to easily adjust the frequency of the lock sound or the amount of reduction in the volume of the high frequency band by setting the thickness of first bent section 35. In addition, as in Embodiment 6 illustrated in FIG. 10, first abutting section 28 may be formed in an inverted U shape in which first connection section 31 extends upward from the proximal end section of first connection section 31 toward the distal end section of first connection section 31 and first abutting main body section 33 extends downward from the proximal end section of first abutting main body section 33 toward the distal end section of first abutting main body section 33. Further, as in Embodiment 7 illustrated in FIG. 11, first abutting section 28 may be formed in an annular shape in which both end sections of first connection section 31 and first abutting main body section 33 are respectively connected to first extending sections 32 and 32. In this case, it is preferable that first bent sections 34 and 35 have a circular arc shape or the like.

It is possible to easily adjust the frequency of the lock sound or the amount of reduction in the volume of the high frequency band by setting any shape as to the shape of each section of first abutting section 28 as described above.

In addition, although the shapes of Embodiments 2 to 7 have been respectively described with regard to first abutting section 28, the shapes may be applied to second abutting section 43 or may be applied to each of first abutting section 28 and second abutting section 43.

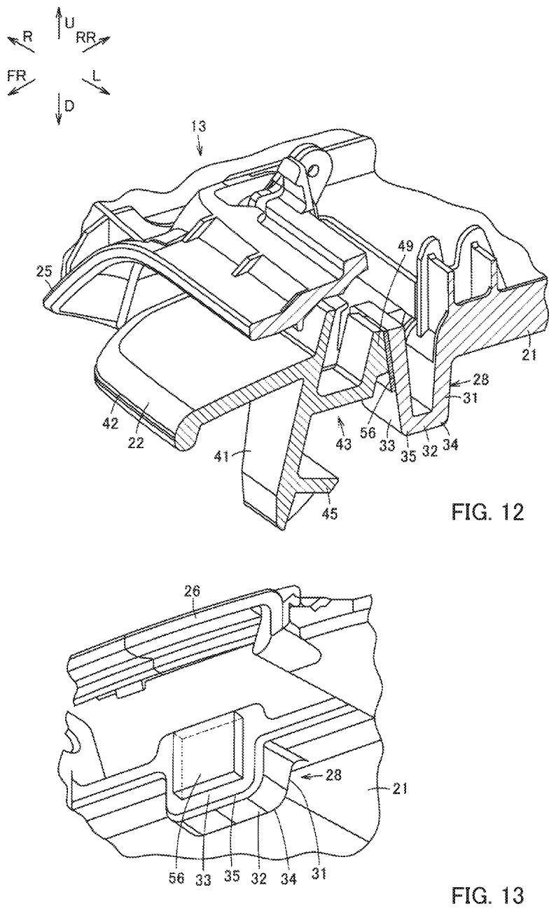

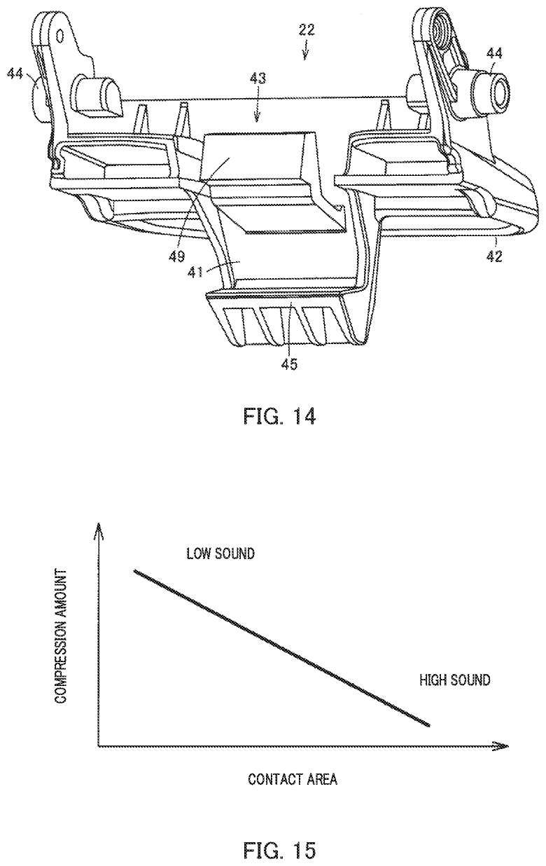

Further, in a case where a cushioning material (cushion material) is set at the position where at least one of first abutting section 28 and second abutting section 43 comes into contact with the other, it is also possible to tune the frequency of the lock sound by adjusting the contact area of the cushioning material. In other words, it is possible to change the lock sound by changing the impact absorption capacity by changing the compression amount of the cushioning material by changing the contact area. For example, cushioning material 56 is disposed on first abutting section 28 in Embodiment 8 illustrated in FIGS. 12 to 15. Cushioning material 56 is disposed on first abutting main body section 33 and is capable of abutting against second abutting main body section 49 of second abutting section 43. In the example illustrated in FIG. 13, cushioning material 56 is formed in a quadrangular shape and the up-down and left-right dimensions of cushioning material 56 serve as a width for lock sound frequency adjustment. Likewise, in second abutting section 43, the up-down and left-right dimensions of second abutting main body section 49 abutting against cushioning material 56 (FIG. 13) serve as a width for lock sound frequency adjustment as illustrated in FIG. 14. It is possible to reduce the compression amount of cushioning material 56 and increase the frequency of the lock sound, that is, change the lock sound to a high sound by increasing the contact area and it is possible to increase the compression amount of cushioning material 56 and reduce the frequency of the lock sound, that is, change the lock sound to a low sound by reducing the contact area (FIG. 15). It is possible to easily change the frequency of the lock sound as desired by changing the contact area between cushioning material 56 disposed on at least one of first abutting section 28 and second abutting section 43 and the other as described above.

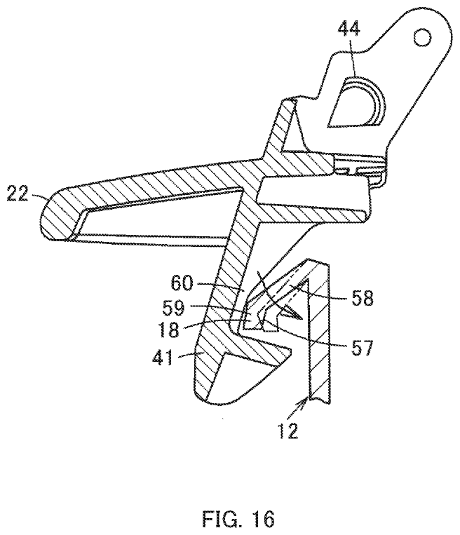

Further, first abutting section 57 may be formed in box main body 12 as in Embodiment 9 illustrated in FIG. 16. For example, first abutting section 57 may be formed in latch section 18. In addition, for example, first abutting section 57 may be formed to include extending section 58 extending from box main body 12 and latch main body section 59 formed in a distal end section of extending section 58. When second abutting section 60 formed on the box main body 12 side of locking section main body 41 of locking section 22 abuts against extending section 58 of first abutting section 57 in the case of closing of opening section 15 by lid body 13, extending section 58 is elastically bent and deformed from the proximal end section to the rear side, which is on the side that is opposite to the direction of the abutment, as indicated by the two-dot chain line, and thus it is possible to achieve the same action and effect as in each of the above embodiments, examples of which include lock sound reduction and absorption of the impact at a time of abutment between first abutting section 57 and second abutting section 60.

In addition, insofar as one of the first abutting section and the second abutting section is a deformation section suppressing the lock sound by deformation, the other may be a rigid body.

Further, the first abutting section may be provided on both box main body 12 and lid body main body 21.

In addition, although console box 10 provided in the passenger compartment of the vehicle has been described in each of the above embodiments, the present invention is not limited to this configuration and is applicable to, for example, any vehicular storage box disposed at another position in the vehicle, examples of which include an accessory case (tray) and a cup holder. In addition, the present invention is applicable to storage apparatuses attached to various places without being limited to use in a vehicle. The present invention is not limited to the storage apparatuses, that is, the opening and closing body is not limited to the lid body that opens and closes the opening section of the storage box and is applicable as a lid apparatus provided with a lid body that covers a part such as an operation section. In addition, the opening and closing body is not limited to the body that is pivotably supported with respect to the main body and may be, for example, movable with respect to the main body by sliding or the like.

### INDUSTRIAL APPLICABILITY

The present invention is suitably used for a console box provided in the passenger compartment of a vehicle, an accessory case or a cup holder having a lid body, or the like.

### REFERENCE SIGNS LIST

10 Opening and closing body apparatus (console box as storage apparatus)
12 Main body (box main body as storage body)
13 Opening and closing body (lid body)
15 Opening section
16 Accommodating section
21 Opening and closing body main body (lid body main body)
22 Locking section
28, 57 First abutting section
33 Abutting main body section (first abutting main body section)
35 Bent section (first bent section)
43, 60 Second abutting section
49 Abutting main body section (second abutting main body section)
52 Bent section (second bent section)
55 Hole

What is claimed is:

1. An opening and closing body apparatus comprising:
a main body; and
an opening and closing body opening and closing at least a part of the main body, wherein
the opening and closing body includes
an opening and closing body main body movable with respect to the main body, and
a locking section movable with respect to the opening and closing body main body and locking the opening and closing body to the main body,
at least one of the main body and the opening and closing body main body has a first abutting section,
the locking section has a second abutting section abutting against the first abutting section when the opening and closing body is locked to the main body by the locking section, and
at least one of the first abutting section and the second abutting section is a deformation section absorbing an impact by being deformed at least in part by abutting against the other.

2. The opening and closing body apparatus according to claim 1, wherein at least one of the first abutting section and the second abutting section is a deformation section provided with an abutting main body section extending along a direction intersecting with a direction of abutment against the other and abutting against the other and a bent section formed to be continuous with the abutting main body section, and bent and deformed.

3. The opening and closing body apparatus according to claim 2, wherein the bent section is set to be smaller in thickness than a part around the bent section.

4. The opening and closing body apparatus according to claim 1, wherein the deformation section is provided with a hole.

5. A storage apparatus comprising the opening and closing body apparatus according to claim 1, wherein
a main body is a storage body having an opening section and an accommodating section communicating with the opening section and accommodating an object, and
an opening and closing body is a lid body opening and closing the opening section.
